(19) United States
(12) Patent Application Publication
(10) Pub. No.: US 2026/0309026 A1
(43) Pub. Date: Oct. 8, 2026

(54) DOWNHOLE SENSING BASED ON TIME DOMAIN REFLECTOMETRY USING RESISTANCE AND CAPACITANCE COUPLING

(71) Applicant: Halliburton Energy Services, Inc., Houston, TX (US)

(72) Inventors: Deepesh Upadrashta, Singapore (SG); Michael Linley Fripp, Singapore (SG)

(21) Appl. No.: 19/171,441

(22) Filed: Apr. 7, 2025

(51) Int. Cl. E21B 47/12; E21B 47/00; E21B 47/07; E21B 49/08; G01V 3/02

(52) U.S. Cl. CPC E21B 47/12; E21B 47/006; E21B 47/07; E21B 49/08; G01V 3/02

(57) ABSTRACT

An apparatus comprising a cable positioned in a wellbore formed in a subsurface formation, where an input signal is to be transmitted along the cable. The apparatus comprises one or more sensors positioned on the cable and configured to cause an impedance mismatch at respective sensor locations on the cable to reflect at least a portion of the input signal.

### BACKGROUND

In hydrocarbon recovery operations, distributed sensing may provide valuable data of the downhole conditions such as movement of fluids, pressure, temperature, corrosion, and health of downhole tools. Although fiber optic sensors are used for monitoring the downhole conditions, they may be limited by their cost, and they often provide qualitative data rather than the quantitative data. Many times, fiber optic lines may not extend into some of the downhole operations.

### BRIEF DESCRIPTION OF THE DRAWINGS

Implementations of the disclosure may be better understood by referencing the accompanying drawings.

FIG. 1 is a diagrammatic illustration of an example well system, according to some implementations.

FIG. 2 is a schematic of an example cable system for monitoring downhole parameters using time domain reflectometry (TDR), according to some implementations.

FIGS. 3A-3D are schematics depicting example cable system configurations where impedance mismatch can be used for sensing various downhole parameters using time domain reflectometry (TDR) principle, according to some implementations.

FIGS. 4A-4B are schematics of an example braided cable design for time domain reflectometry (TDR) based sensing, according to some implementations.

FIGS. 5A-5B are schematics of example cable designs for sensing various downhole parameters using time domain reflectometry (TDR) principle, according to some implementations.

FIGS. 6A-6B are schematics of a first example of sensors for measuring downhole parameters, according to some implementations.

FIG. 7 is a schematic of a second example of sensors for measuring downhole parameters, according to some implementations.

FIG. 8 is a flowchart depicting example operations for determining downhole parameters with time domain reflectometry, according to some implementations.

FIG. 9 is a block diagram depicting an example computer, according to some implementations.

### DESCRIPTION

The description that follows includes example systems, methods, techniques, and program flows that embody aspects of the disclosure. However, it is understood that this disclosure may be practiced without these specific details. Aspects of this disclosure can also be applied to any other wellbore operations before, during, and/or after hydraulic fracturing to modify the distribution of effective energy in a drill space unit.

Unless otherwise specified, use of the terms “connect,” “engage,” “couple,” “attach,” or any other like term describing an interaction between elements is not meant to limit the interaction to a direct interaction between the elements and may also include an indirect interaction between the elements described. Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subsurface formation” shall be construed as encompassing both areas below exposed earth and areas below earth covered by water such as ocean or fresh water.

Example implementations may include a distributed sensing technology based on time domain reflectometry (TDR) to measure one or more downhole parameters in a wellbore. Example implementations are in contrast to conventional approaches that may use fiber optic sensors. Fiber optic sensors may be limited in use for certain downhole operations (such as operations in dynamic requirements that require repeated movements or tensile stress, like on drilling rigs). Additionally, the fiber optic sensors and the installation of the fiber optic sensors may be costly. Moreover, the fiber optic sensors may be limited in which downhole parameters may be measured.

In contrast, example implementations may use distributing sensing based on time domain reflectometry (TDR) with an electric cable and one or more sensors to measure downhole parameters. Such implementation may be more cost effective and may measure more downhole parameters compared to conventional approaches. When the impedance of a downhole cable changes locally due to the change in downhole conditions, at least a portion of the input electrical signal or pulse transmitted on the cable may be reflected in the opposite direction due to the impedance mismatch. Impedance mismatch may occur when there is a difference in impedance between two components and/or mediums, such as a wire and a sensor. This mismatch may disrupt the transfer of energy, often resulting in reflection. The impedance of the electrical system is measured in ohms that may be expressed as a complex value with a resistive load that forms the real part and a reactive load that forms the imaginary part. When there is an impedance mismatch, then there may be a reflection. The magnitude of the reflection induced by the impedance mismatch may be expressed as a reflection coefficient. The reflection coefficient may be mathematically calculated as the difference between the mismatched impedances divided by the sum of the mismatched impedances. In a straight wire without connections, in other words a wire with matched impedance, the reflection coefficient may be, for example, less than 0.001%. When there is an impedance mismatch, the reflection coefficient may, for example, be greater than 0.01% and may typically be greater than 1%. The reflection coefficient may be a complex value and, thus, may have a different value at different frequencies. The system may be considered to exhibit an impedance mismatch when the reflection coefficient at a testable frequency exceeds 0.01% and, preferably, greater than 1%. For example, an input signal processor, configured to generate, transmit and/or analyze an input signal on the cable, may be positioned at the surface (or downhole) and generate an input signal on the cable. The input signal may transmit downhole on the cable. If the input signal encounters an impedance mismatch, at least a portion of the input signal may be reflected back uphole to the input signal processor. One or more sensors positioned along the cable may be configured to induce the change in the impedance with a change in the downhole parameters to generate the impedance mismatch for reflecting the input signal. For example, the sensors may be a material (such as steel) that is at least partially exposed to the downhole conditions (i.e., fluids, temperature, pressure, etc.). The downhole conditions may modify the material (structurally, chemically, etc. such as corrosion, expansion, contraction, etc.) that may induce an impedance discontinuity. The varying downhole conditions may modify the cable capacitance, resistance, or a combination of both. Such modifications and the corresponding impedance mismatch may result in reflection of at least a portion of the input signal. The changes in the reflected input signal analyzed in time domain characteristics (such as amplitude, duration, phase, frequency, etc. of the reflected wave) may be used for measuring the downhole parameters. For example, downhole parameters may include temperature, corrosion rate, salinity, fluid composition, etc. In some implementations, the response of the reflected signals can be averaged over large samples to reduce the noise in the time series signal and for better prediction of measurements of downhole parameters.

In some implementations, the cable and one more sensors deployed in the wellbore may be designed exclusively for sensing downhole parameters utilizing Time Domain Reflectometry (TDR) principles. It may not be intended or configured to transmit electrical power to downhole devices or equipment. For example, the cable may not supply power to pumps, flow control devices, etc.

### Example System

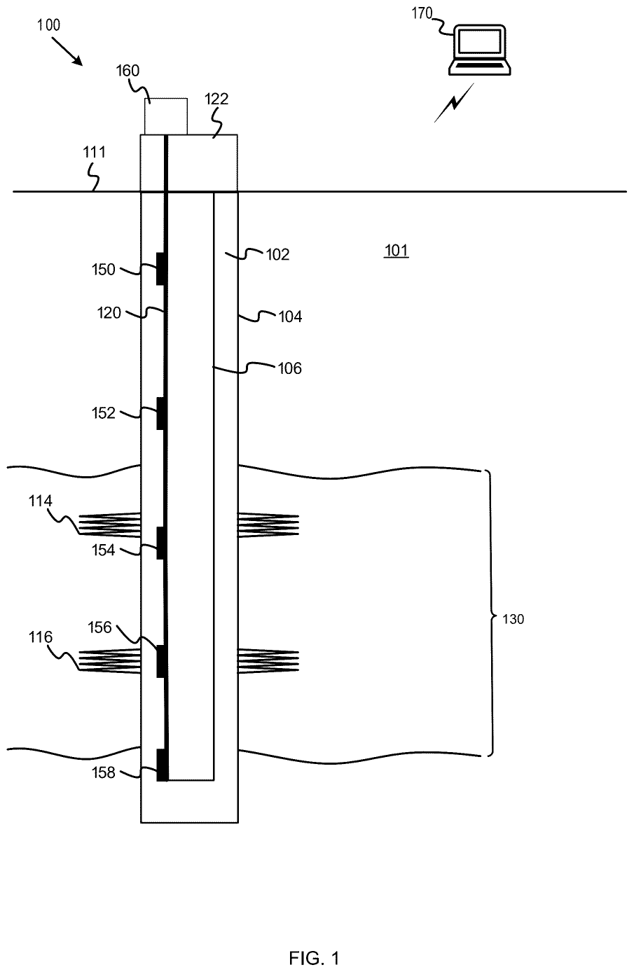

FIG. 1 is a diagrammatic illustration of an example well system, according to some implementations. In particular, FIG. 1 is a schematic of a well system 100 that includes a wellbore 102 in a subsurface formation 101. The wellbore 102 includes casing 104 and number of perforations 114, 116 being made in the casing 104. Each set of perforations 114, 116 is located in a reservoir 130 to allow reservoir fluids (i.e., oil, water, and gas) from the reservoirs 130 to flow into the wellbore 102. When fluid may be produced into the wellbore 102, the production fluid may flow up the production tubing 106, through the wellhead 122 and ultimately to production facilities for further processing. In some implementations, other equipment may be positioned in the wellbore 102 such as a packer, sleeves, profiles, screens, pumps, etc.

In some implementations, a cable 120 may be positioned in the wellbore. While the well system 100 depicts the cable 120 positioned on the outside of the production tubing 106, the cable 120 may be positioned at any suitable location in the wellbore 102 such as on the inside of the production tubing 106, on the outside of the casing 104, in the annular region between the casing 104 and the production tubing 106, in cement encasing the casing 104, etc. Additionally, the cable 120 may be any suitable length. For example, the cable 120 may extend from the wellhead 122 to the end of the production tubing 106, 5,000 feet in the wellbore, to the top of a curve in a horizontal wellbore, the entire length of the wellbore 102, etc. In some implementations, one or more sensors, such as sensors 150-158, may be positioned on the cable 120. The sensors 150-158 may be at least a portion of the cable 120 or separate and coupled with the cable 120. Moreover, the sensors 150-158 may be any suitable length. For example, a sensor may be less than an inch, or the sensor may be the entire cable 120 itself. The sensors 150-158 may be configured to cause an impedance mismatch in the cable such that at least a portion of an input signal is reflected in the opposite direction while the remaining may continue transmitting along the cable 120, as further described below.

In some implementations, an input signal processor 160 may be coupled with the cable 120 and configured to generate an input signal on the cable 120. Additionally, the input signal processor 160 may be configured to obtain and analyze the reflected signal generated by the one or more sensors 150-158 to determine downhole parameters at the respective locations of the sensors 150-158. While the well system 100 depicts the input signal processor 160 at the surface 111 proximate the wellhead 122, the input signal processor 160 may be at any location such as any other location on the surface 111, downhole in the wellbore 102, etc.

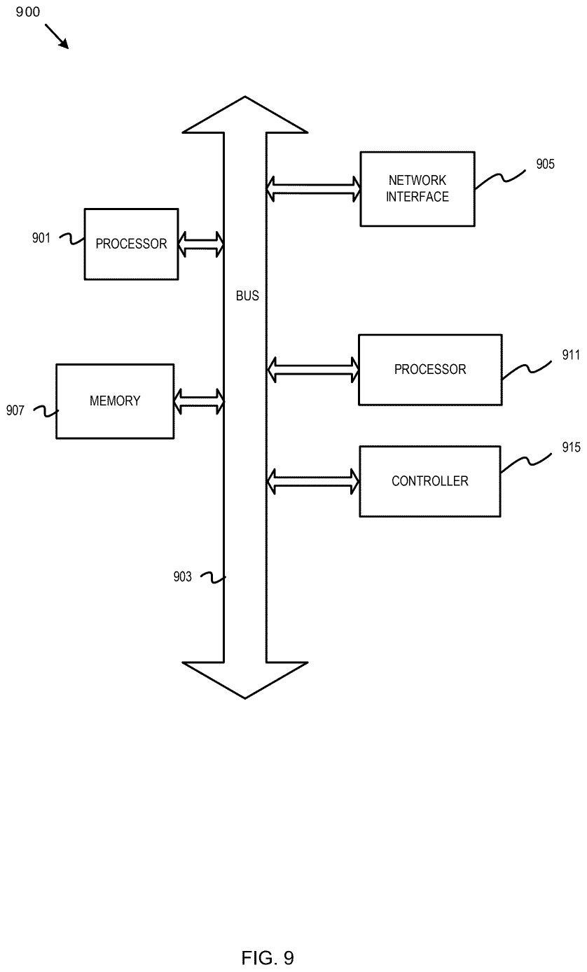

A computer 170 may be communicatively coupled to the signal processor 160 and other components in the well system 100. The computer 170 may include a signal processor to perform various signal processing operations on signals captured by input signal processor 160 and/or other components of the well system 100. The computer 170 may have one or more processors and a memory device to analyze the measurements and graphically represent analysis results on a display device. In some implementations, the computer 170 may be utilized to determine the downhole parameters at the respective locations of the sensors 150-158. An example of the computer 170 is depicted in FIG. 9, and further described below.

While a well system 100 of FIG. 1 illustrates a land-based subterranean environment, example implementations may be included in any well site environment including a subsea environment. In some implementations, any one or more components or elements may be used with subterranean operations equipment located on offshore platforms, drill ships, semi-submersibles, drilling barges and land-based rigs. Moreover, example implementations may be included in any wellbore including vertical, horizontal, deviated, etc.

### Example Cable Systems

Example cable systems configured for time domain reflectometry (TDR) are now described.

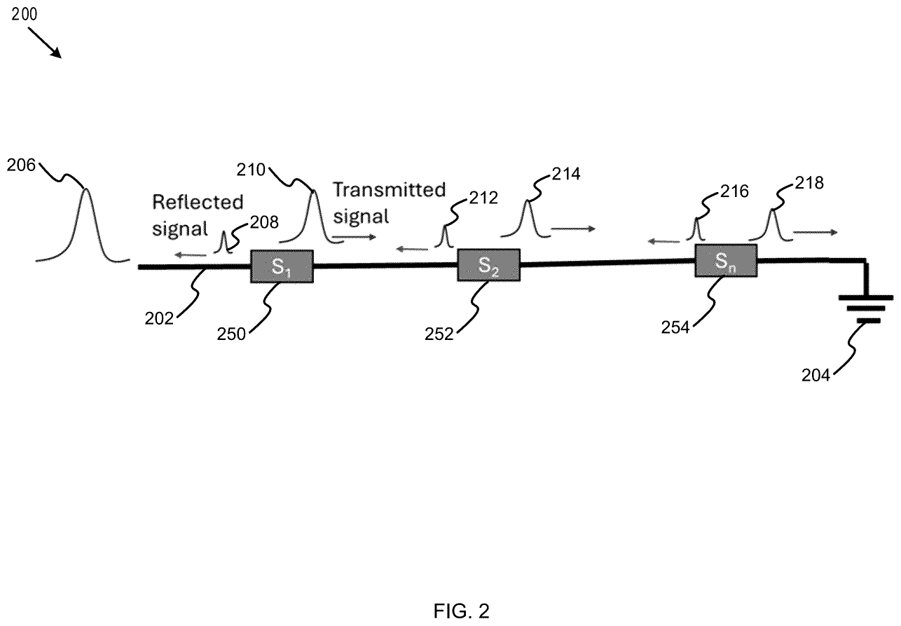

FIG. 2 is a schematic of an example cable system for monitoring downhole parameters using time domain reflectometry (TDR), according to some implementations. FIG. 2 includes a cable 202 and a plurality of sensors 250, 252, 254 positioned on the cable. The cable 202 may be a single wire or multi-wire. In some implementations, if the cable 202 is multi-wire, the wires may be of different materials (such as copper and steel). Various downhole sensors may be coupled to the cable for TDR based downhole monitoring such as resistance-based temperature sensors, capacitance-based water cut sensors, inductance-based salinity sensors, etc. or any combination thereof. The impedance may be varied at each sensor 250, 252, 254 by modification of the resistance, capacitance, or both locally for achieving downhole monitoring. TDR may be used for monitoring downhole parameter. TDR includes sending an input signal 206 along a cable 202. For example, with reference to FIG. 1, an input signal processor 160 may generate the input signal 206 such that the input signal 206 travels along the cable in the downhole direction. When the input signal 206 encounters a discontinuity of impedance (such as at a sensor, as further described below), at least a portion of the input signal 206 may be reflected while the remaining input signal 206 may continue transmitting in the downhole direction. For example, the input signal 206 (such as an electric pulse, sine wave, frequency sweep, etc.) may be sent down the cable 202 in a first direction. At least a portion of the input signal 206 may be reflected at the sensor 250 due to the impedance mismatch encountered at the sensor 250 location. The reflected signal 208 may transmit in the opposite direction back towards the input signal processor 160 for analysis. The remaining transmitted signal 210 may continue transmitting along the cable 202 in the first direction. At least a portion of the transmitted signal 210 may be reflected due to the impedance mismatch at the sensor 252 location. The reflected signal 212 may transmit in the opposite direction back towards the input signal processor 160 for analysis. The remaining transmitted signal 214 may continue transmitting along the cable 202 in the first direction. At least a portion of the transmitted signal 214 may be reflected due to the impedance mismatch at the sensor 254 location. The reflected signal 216 may transmit in the opposite direction back towards the input signal processor 160 for analysis. The remaining transmitting signal 218 may continue transmitting to the end of the cable 202 to the ground 204.

In some implementations, downhole parameters may be measured by analyzing the time-domain response of the reflected signals 208, 212, 216. For example, downhole parameters such as temperature, corrosion, salinity, fluid compositions, etc. Various features of the reflected signals 208, 212, 216 such as amplitude, root mean square (RMS), mean, shape factor, crest factor, duration, etc. may be used for correlating downhole parameters. In some implementations, when analyzing the frequency components in the time domain response of the reflected signals, noise may be mitigated for more accurate measurements. Such mitigation techniques may include averaging the time domain response over large sample sizes (e.g., ranging from thousands to millions of samples). In some implementations, the incident signal sent on the cable 202 may be in the range of kilohertz (kHz) to megahertz (MHz) frequency. For example, the averaging of the samples may be recording the time-domain data for a time period (such as 1 second, 2 second, 30 seconds, etc.) and post processing to measure the downhole parameters at the respective locations of the sensors 250, 252, 254. In some implementations, the signal sent down the different wired may be combined, such as the signal may be sent from one end of the wire and then sent from the other end of the wire. In some implementations, the signals sent along different wires in a wire bundle may be combined (i.e., both signals are input into a TDR algorithm).

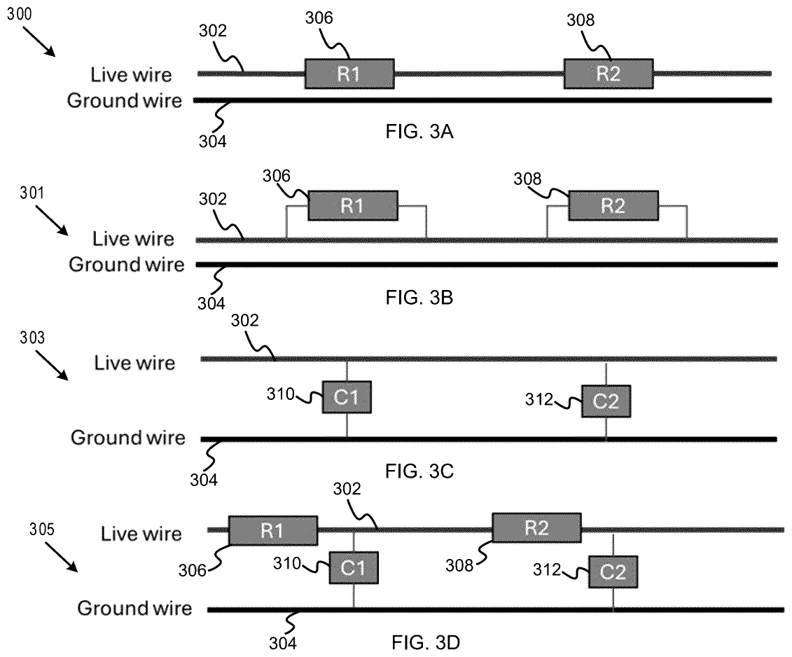

FIGS. 3A-3D are schematics depicting example cable system configurations where impedance mismatch can be used for sensing various downhole parameters using time domain reflectometry (TDR) principle, according to some implementations. FIG. 3A includes a cable system 300 comprising a live wire 302 and ground wire 304. In the example implementation, the resistance-based sensors 306, 308 are positioned in series on the live wire 302. FIG. 3B includes a cable system 301 comprising a live wire 302 and ground wire 304. In the example implementation, the resistance-based sensors 306, 308 are positioned in parallel on the live wire 302. FIG. 3C includes a cable system 303 comprising a live wire 302 and ground wire 304. In the example implementation, the capacitance-based sensors 310, 312 are positioned in parallel between the live wire 302 and the ground wire 304. FIG. 3D includes a cable system 305 comprising a live wire 302 and ground wire 304. In the example implementation, the cable system 305 includes a combination of resistance-based sensors 306, 308 on the live wire 302 and the capacitance-based sensors 310, 312 between the live wire 302 and the ground wire 304. Any suitable configuration and/or combination of resistance-based sensors and capacitance-based sensors may be utilized in the cable system to determine local downhole parameters via TDR.

### Example Cables

Example cable designs are now described. The example cable designs further described below may introduce local resistance and/or capacitance changes to monitor the downhole parameters.

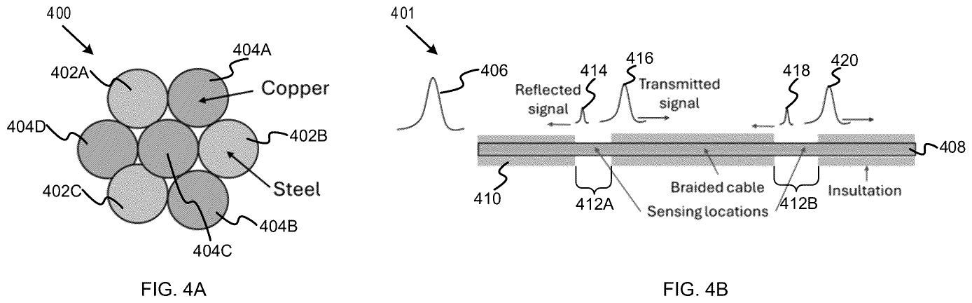

FIGS. 4A-4B are schematics of an example braided cable design for time domain reflectometry (TDR) based sensing, according to some implementations. FIG. 4A includes a cross section 400 of a braided wire comprising two metals such as steel 402A-C and copper 404A-404D. The steel 402A-C may be any suitable steel allow such as carbon steel, stainless steel, etc. Additionally, the copper 404A-404D may be copper, a copper alloy, etc. While the example implementations depict steel and copper, the wires may comprise any other suitable materials with different material properties. For example, a first wire may be a non-corrodible material (such as copper, stainless steel) and a second wire may be a corrodible material (such as steel), a first wire may be non-degradable and the second wire may be degradable, etc. The materials may be selected based on the downhole conditions and/or downhole parameters that may be of interest. For example, for hydrogen embrittlement, the non-corrosive wire may comprise aluminum and the corrosive wire may comprise Inconel 718. Alternatively, for alkaline fluids or acidic fluids, the corrosive wire may comprise aluminum and the non-corrosive wire may comprise Inconel 718. In some implementations, the non-corrosive wire may have a high electrical conductivity relative to the other wires in the cable such that as the corrosive wire corrodes, the reduction in the conductivity of the cable limited and the cable may still be functional for TDR based sensing of downhole parameters.

While the example implementation depicts two materials, one or more than two materials may be used. For example, in addition to the copper wire, the cable can include two or more other metallic wires to measure multiple parameters from the same locations (as described below). For instance, the cable may include a copper wire, and different types of steel wires that react differently to downhole parameters. While the example implementation depicts copper and steel wires, any other suitable materials may be used such that different wires differ in durability in the downhole environment in their response to the downhole parameter.

FIG. 4B includes a braided cable 401 comprising a cable 408 with braided wires as described in FIG. 4A. Shield 410 may encase at least a portion of the cable 408 to provide the cable 408 with protection from downhole conditions. The shield 410 may prevent chemical corrosion of the wire, resulting in knowing the location at which the corrosion may be occurring. The shield 410 may be an electrical insulator including, but not limited to, polymer, glass, ceramic, etc. The shield 410 may be electrically conductive such as metallic cladding or coating including, but not limited to, stainless steel, nickel, copper, or any other suitable non degradable material. In some implementations, the shield may include multiple layers of material. For example, a first layer may be electrically conductive material, and a second layer may be electrically insulating material. In some implementations, at least a portion of the cable 408 may not be encased by the shield 410 to expose the cable 408 to the downhole conditions, such as exposed section 412A and 412B. The exposed sections 412A, 412B may be any suitable length. For instance, the exposed sections 412A, 412B may be less than an inch or the entire length of the cable 408 (i.e., there is no shield 410 on the cable). Accordingly, exposed section 412A and 412B may function as a sensing location for downhole monitoring with TDR.

For example, the exposed section 412A and 412B may induce local resistance variance with the corrosion of the steel cables, temperature variations in the downhole environment, etc. Thus, when an input signal is transmitted down the cable 408, at least a portion of the input signal 406 may be reflected off of the exposed section 412A due to the impedance mismatch. TDR may be used to determine downhole parameters at the exposed section 412A based on the reflected signal 414. The transmitted signal 416 (the remaining input signal 406 not reflected at the exposed section 412A) may continue transmitting towards the exposed section 412B, where at least a portion may be reflected in the opposite direction. TDR may be used to determine downhole parameters at the exposed section 412B based on the reflected signal 418. The transmitted signal 420 (the remaining input signal 406 not reflected at the exposed section 412B) may continue transmitting on the cable 408.

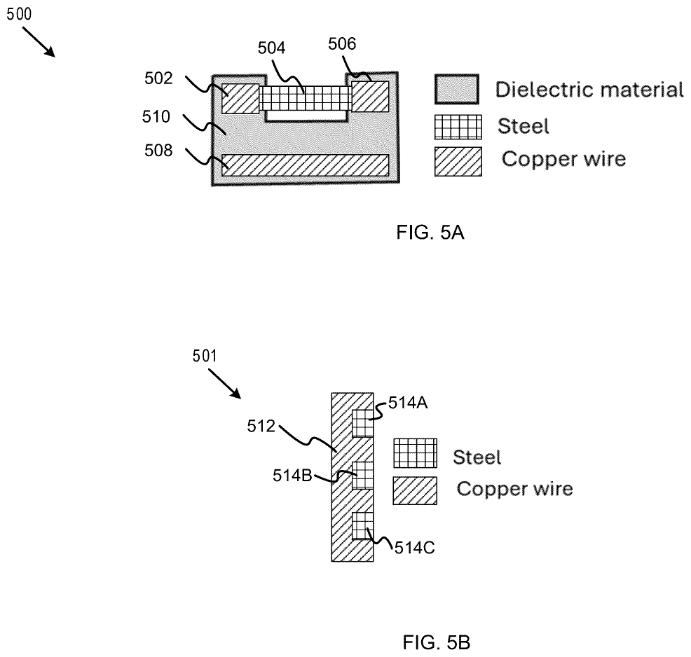

FIGS. 5A-5B are schematics of example cable designs for sensing various downhole parameters using time domain reflectometry (TDR) principle, according to some implementations. FIG. 5A includes a cable 500 configured for sensing downhole parameters on the principle of TDR (as described above). In some implementations, the cable 500 may be an alternate configuration for one or more of the sensors (i.e., exposed sections 412A, 412B) described in FIG. 4B. In the example implementation shown in FIG. 5A, the cable 500 includes a copper wire 502 and a copper wire 508. The material of the copper wires 502, 508 may be copper, copper alloy, or any other suitable conductive material. Steel 504 may be integrated with the copper wire 502 and configured to react to the downhole conditions (fluids, temperature, etc.). The steel may be carbon steel, stainless steel, or any other suitable material that reacts to downhole conditions. For example, rather than steel, the material could be other metallics that react to temperature, acidity levels, etc. In some implementations, rather than a section of the copper wire 502 be steel 504, the entire wire may be a continuous steel wire with only a section of the steel 540 exposed (i.e., not encased by the dielectric material 510). A dielectric material 510 (such as PEEK) may encase the copper wires 502, 508, but not encase the steel 504 such that the steel 504 may be exposed to downhole conditions. Accordingly, the steel 540 may function as a sensor as described above. When the steel 504 corrodes, expands, or contracts, etc., the resistance and capacitance of the cable may change locally. In some implementations, the steel 504 may be exposed to the downhole conditions at discrete locations only, and protected by the dielectric material 510 in the remaining portion of the cable 500.

FIG. 5B includes a wire 501 configured for sensing downhole parameters on the principle of TDR (as described above) with a cable, such as cable 500. The wire 501 includes a single wire that may be utilized for sensing or in combination with ground wire. The wire 501 includes copper 512 (or any other suitable conductive material) and steel 514A-C (or any other suitable material for reacting to downhole conditions). The steel 514A-C may be additively deposited or pressed on the copper 512. The steel 514A-C is shown as respective segments integrated into the copper 512. The segments of steel 514A-C may be any suitable length and any suitable distance from other segments. The segments may be equally spaced or the spacing may vary. For example, the spacing may be closer for areas of interest in a wellbore (such as across a perforated zone) and greater for other areas (such as in a vertical section of the wellbore near the surface). When the steel 514A-C reacts to the downhole environment (e.g., expands, contracts, corrodes, etc. with variation in downhole conditions), the resistance of the wire 501 may change locally. The corresponding impedance change may reflect the input signal (as described above), and the characteristics of the reflected signal may be utilized for measuring the downhole parameters at the respective location of the steel 514A-C. In some implementations, the copper 512 may be coated with a non-corrosive coating.

### Example Sensors

Example sensors are now described. The example sensors further described below may introduce local resistance and/or capacitance changes to monitor the downhole parameters. The sensors described below may be sensors coupled with a single or multiwire cable (such as the cables described in FIGS. 4A-B and FIGS. 5A-B).

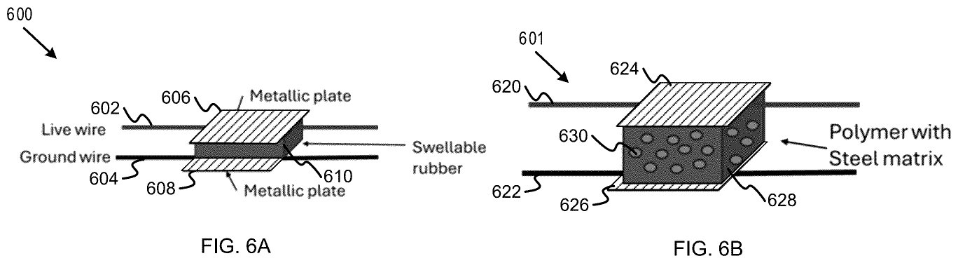

FIGS. 6A-6B are schematics of a first example of sensors for measuring downhole parameters, according to some implementations. FIG. 6A includes a capacitor 600 positioned on a cable and configured to measure salinity using TDR principles. The capacitor 600 includes metallic plates 606, 608 separated by a dielectric material 610. The metallic plates 606, 608 may include any suitable conductive material, such as copper. In some implementations, the metallic plates may be encased with a non-conductive material to protect the metallic plates 606, 608 from the downhole environment. The dielectric material 610 may be any suitable material that reacts to the downhole hole conditions. For example, the dielectric material 610 may include swellable elastomer configured to expand or contract depending on the properties of a fluid it may be exposed to. The swellable material may swell with changes in the salinity of water, changes in oil composition, etc. In some implementations, the dielectric material 610 may degrade when exposed to downhole fluids. For example, degradation may occur when the dielectric material absorbs fluid, such as swelling in water, oil, carbon dioxide (CO2), hydrogen (H2), etc. Another example of degradation may be when the dielectric material chemically reacts with the fluids, such as when an aliphatic polyester (such as Polylactic Acid (PLA) or Polyglycolic Acid (PGA)) that may degrade in water without swelling. Thus, the dielectric material may have the electrodes degrade or the dielectric degrade. As the dielectric degrades, its dielectric permittivity may go up or it may go down. A metallic plate 606 and a metallic plate 608 may be positioned on a live wire 602 and a ground wire 604, respectively.

Capacitance may be varied by changing the distance between the metallic plates 606, 608 of the capacitor 600 and/or by changing the dielectric material properties of the medium between the metallic plates. The spacing between the metallic plates 606, 608 may vary with the expanding and/or contracting of the dielectric material 610 if the salinity of fluid (or other downhole parameter such as oil composition, temperature, etc., depending on the material of the dielectric material 610) in which the dielectric material 610 is exposed to changes. Therefore, when the downhole parameter changes, the capacitance changes and in turn affects the characteristics of the reflected signal (as described above). For example, the dielectric may include a water absorbing material. The capacitance of the capacitor 600 may change as the water absorbing material interacts with the water. Accordingly, the distance between the metal plates may change as water enters a water-swelling elastomer or may change as oil enters an oil-swelling elastomer. The dielectric permeability of the capacitor 600 may change as the fluids enter a non-expanding porous structure (like a ceramic foam). As another example, the dielectric material 610 may expand when the salinity of water increases. Accordingly, the distance between the metallic plates 606, 608 may also increase. Thus, the capacitance may change due to the salinity, and the reflected signal at the capacitor 600 may capture this change. Any suitable material(s) that react to various downhole parameters may be positioned between the metallic plates 606, 608 to alter the capacitance and hence, create an impedance mismatch.

FIG. 6B includes a capacitor 601 positioned on a cable and configured to measure corrosion using TDR principles. The capacitor 601 includes similar components as the capacitor 600 of FIG. 6A. For example, the capacitor 601 includes metallic plates 624, 626 positioned on a live wire 620 and a ground wire 622, respectively. However, the material separating the metallic plates 624, 626 may include a dielectric medium 630 comprising a polymer with a steel matrix such as carbon steel. When the dielectric medium 630 is exposed to the downhole fluids, at least a portion of the steel may corrode. Accordingly, the properties of the dielectric medium 630 may change and hence, the capacitance may change. For example, if the steel matrix at least partially corrodes, the loss of material may result in the spacing between the metallic plates 624, 626 to decrease as the metal goes into solution or to increase if the metal becomes a metal hydroxide which has larger volume. The dielectric permittivity of the dielectric medium 630 may change. This may result in a change in capacitance and the reflected signal at the capacitor 601 may capture this change to determine the corrosion rate. In some implementations, the dielectric material may include a matrix comprising materials that may react to acidity levels. For example, magnesium, aluminum, etc. may be included in the dielectric medium 630 such that when exposed to the downhole fluids, the material may dissolve and hence, change the distance between the metallic plates 624, 626. In some implementations, the dielectric medium 630 may include a sponge configured to absorb fluid based on the fluid salinity. In some implementations, the polymer within the dielectric medium be a non-reactive material such that it may not expand or contract in the downhole environment when the matrix material corrodes, dissolves, etc. Any suitable material(s) that react to various downhole parameters may be positioned between the metallic plates 624, 626 to alter the capacitance and hence, create an impedance mismatch.

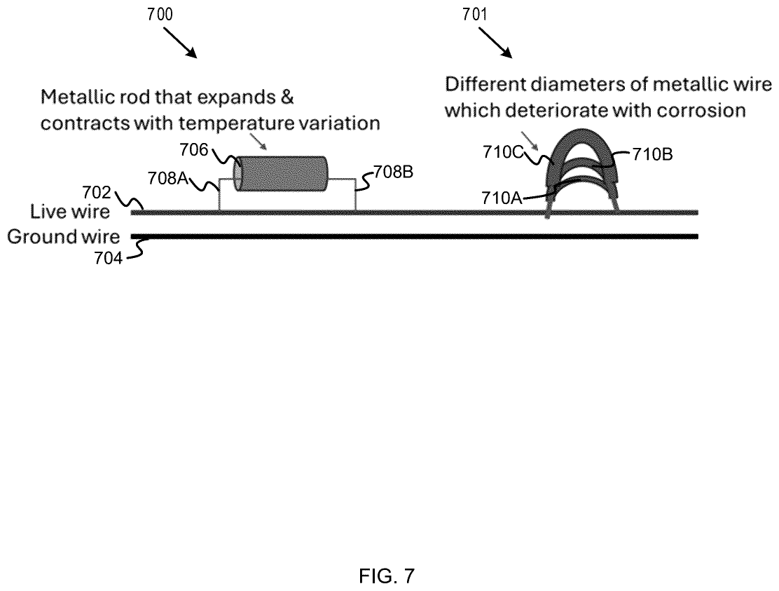

FIG. 7 is a schematic of a second example of sensors for measuring downhole parameters, according to some implementations. FIG. 7 includes sensor 700 and sensor 701, positioned in parallel on a cable. Each of the sensors 700, 701 may be configured with metallic components, such as one or more rods, plates, wires, etc. to induce a change in resistance to reflect an input signal and subsequently determine the downhole parameters based on the characteristics of the reflected signals. In the example implementation, the cable includes a live wire 702 and a ground wire 704. The sensor 700 and the sensor 701 may be positioned on the live wire 702.

The sensor 700 may include a metallic rod 706 that is coupled to the live wire 702 via the wires 708A and 708B. Resistance of the metallic rod 706 may change with a change in the downhole temperature. The properties of the metallic rod 706 may be known such that the change in resistance of the metallic rod 706 may be mapped to the change in temperature Hence, impedance may change as the temperature changes, which may be captures in the reflected signals. In some implementations, the metallic rod 706 may be configured to expand and contract (in the diametric direction and/or axial direction) with changes in local downhole temperatures. Accordingly, this may result in a change in resistance and the reflected signal at the sensor 700 may capture this change to determine the temperature and the length of the metallic rod 706.

The sensor 701 may include one or more metallic wires, such as wires 710A-C, coupled with the live wire 702. The initial resistance at the sensor 701 may be the combination of the resistance of the wires 710A-C. Any of the wires 710A-C may corrode over time and thus, the effective resistance of the sensor 701 may change. Such change in resistance at the sensor 701 may be captured by the reflected signal, allowing the corrosion to be determined from the reflected signal. In some implementations, each of the wires 710A-C may have a different diameter, as shown in FIG. 7. For example, the wire 710A may have a smaller diameter than the wire 710B, and the wire 710B may have a smaller diameter than the wire 710C. When the wire 710A corrodes, the resistance of the sensor 701 may change and hence, characteristics of reflected wave at the sensor location may also vary. This may be repeated when the wire 710B corrodes, and subsequently the wire 710C corrodes.

In some implementations, the resistivity of the materials of wires 710A-C and the metallic rod 706 or the resistance of the sensor 700, 701 should be less than the local resistance of the sensor cable for the combined resistance to vary when the metallic rod 706, and/or the wires 710A-C expands or contracts or corrodes. For instance, if the live wire 702 is made of stainless steel, the metallic rod 706 of the sensor 700 should be made of a material with lower resistivity, such as carbon steel.

In some implementations, the steel materials of the aforementioned sensors (wires of exposed areas 412A, B of FIG. 5B, steel 504 of FIGS. 5A-5B, capacitor 601 of FIG. 6B, sensors 700 and 701 of FIG. 7) may be steel similar to or different than steel used in a wellbore. For example, the steel in the dielectric medium 630 of the capacitor 601, the metallic rod 706, and/or the wires 710A-C may be made of a material similar to the material of downhole equipment in the wellbore (e.g., casing, tubing, etc.) such that the sensors may mirror what may be occurring in the wellbore equipment. For instance, the wires 710A-C may corrode at a rate similar to the corrosion rate of a tubular in the wellbore if made of the same or approximately similar material. In some implementations, the materials in the sensor may be different than the materials in the wellbore. For example, the corrosion rate of a steel in a sensor may be greater than the corrosion rate of a tubular to function as a warning that corrosion of the tubular may occur in the future. In some implementations, the materials may have a corrosion rate equal to, or proportionate to materials of downhole components in the wellbore. For example, the change in corrosion of the wires 710A-C may be mapped to a predicted change in corrosion in downhole components in the wellbore, such as casing.

### Example Operations

Examples Operations Are Now Described.

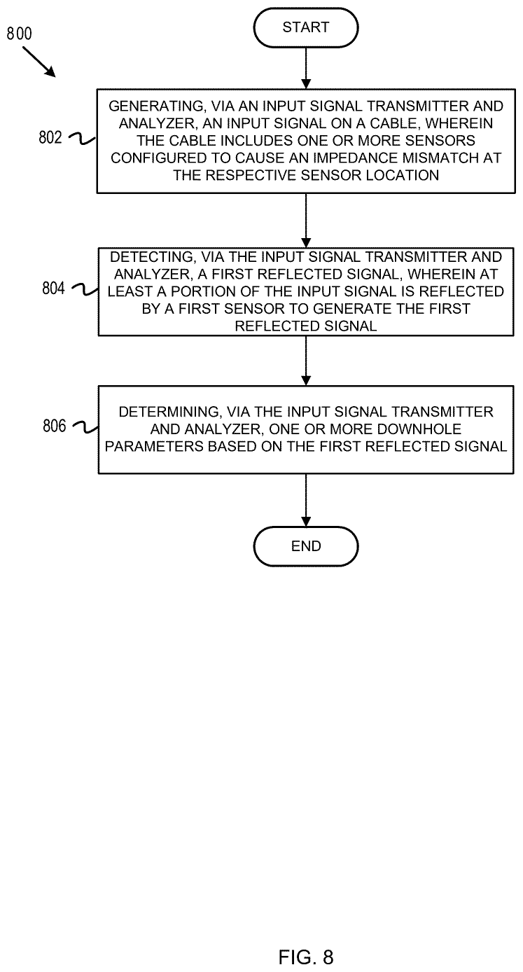

FIG. 8 is a flowchart depicting example operations for determining downhole parameters with time domain reflectometry, according to some implementations. FIG. 8 includes a flowchart 800 for utilizing one or more sensors positioned on a cable to determine local downhole parameters based on time domain reflectometry (TDR). The operations of the flowchart are described in reference to the input signal processor 160 and processor of the computer 170 of FIG. 1. Additionally, the operations of the flowchart 800 may be applicable utilizing any one or more of the sensors described in FIGS. 3-7. The operations of the flowchart 800 begin at block 802.

At block 802, an input signal processor may generate an input signal on a cable, wherein the cable includes one or more sensors configured to cause an impedance mismatch at the respective sensor location.

At block 804, the input signal processor may detect a first reflected signal, wherein at least a portion of the input signal is reflected by a first sensor to generate the first reflected signal.

At block 806, the input signal processor may determine one or more downhole parameters based on the first reflected signal Subsequent reflections from other sensors positioned on the cable may provide information from the corresponding sensor (as described above in FIG. 2).

While the aspects of the disclosure are described with reference to various implementations and exploitations, it will be understood that these aspects are illustrative and that the scope of the claims is not limited to them. In general, using a cable and one or more sensors for time domain reflectometry to monitor downhole conditions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded with the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

Unless otherwise specified, use of the terms “up,” “upper,” “upward,” “uphole,” “upstream,” or other like terms shall be construed as generally away from the bottom, terminal end of a well; likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

### Example Computer

FIG. 9 is a block diagram depicting an example computer, according to some implementations. FIG. 9 depicts a computer 900 for monitoring downhole conditions using time domain reflectometry with a cable and sensor system. The computer 900 includes a processor 901 (possibly including multiple processors, multiple cores, multiple nodes, and/or implementing multi-threading, etc.). The computer 900 includes a memory 907. The memory 907 may be system memory or any one or more of the above already described possible realizations of machine-readable media. The computer 900 also includes a bus 903 and a network interface 905. The computer 900 can communicate via transmissions to and/or from remote devices via the network interface 905 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 900 also includes a processor 911 and a controller 915 which may perform the operations described herein. For example, the processor 911 may obtain reflected signals, and determine one or more downhole parameters based on the reflected signals. The controller 915 may generate input signals that are transmitted on a cable. The processor 911 and the controller 915 can be in communication. Any one of the previously described functionalities may be partially (or entirely) implemented in hardware and/or on the processor 901. For example, the functionality may be implemented with an application specific integrated circuit, logic implemented in the processor 901, in a co-processor on a peripheral device or card, etc. Further, realizations may include fewer or additional components not illustrated in FIG. 9 (e.g., video cards, audio cards, additional network interfaces, peripheral devices, etc.). The processor 901 and the network interface 905 are coupled to the bus 903. Although illustrated as being coupled to the bus 903, the memory 907 may be coupled to the processor 901.

### Example Implementations

Implementation #1: An apparatus comprising: a cable positioned in a wellbore formed in a subsurface formation, wherein an input signal is to be transmitted along the cable; and one or more sensors positioned on the cable and configured to cause an impedance mismatch at respective sensor locations on the cable to reflect at least a portion of the input signal.
Implementation #2: The apparatus of Implementation #1, wherein the input signal transmits along the cable in a first direction, and wherein one or more reflected signals transmit along the cable in a second direction that is opposite the first direction.
Implementation #3: The apparatus of Implementation #2 further comprising: an input signal processor configured to send the input signal along the cable in the first direction, wherein the input signal processor is configured to determine one or more downhole parameters based on time domain characteristics of the one or more reflected signals.
Implementation #4: The apparatus of Implementation #3, wherein the downhole parameters include temperature, salinity, corrosion rate, fluid composition, or any combination thereof.
Implementation #5: The apparatus of any one or more of Implementation #1-4, wherein the one or more sensors include at least a portion of one or more wires within the cable, one or more components coupled with the one or more wires within the cable, or any combination thereof.
Implementation #6: The apparatus of any one or more of Implementation #1-5, wherein the one or more sensors includes two or more materials, wherein a first material exposed to wellbore fluids at the respective sensor locations.
Implementation #7: The apparatus of any one or more of Implementation #1-6, wherein the cable includes one or more wires, and wherein a first sensor of the one or more sensors is at least a portion of a first wire of the one or more wires that is exposed to downhole conditions.
Implementation #8: The apparatus of any one or more of Implementation #1-7, wherein the one or more sensors modifies at least one of resistance and capacitance to cause the impedance mismatch.
Implementation #9: A system comprising: a cable positioned in a wellbore formed in a subsurface formation, wherein an input signal is to be transmitted along the cable; an input signal processor configured to send the input signal along the cable in a first direction; and one or more sensors positioned on the cable and configured to cause an impedance mismatch at respective sensor locations on the cable to reflect at least a portion of the input signal.
Implementation #10: The system of Implementation #9, wherein one or more reflected signals transmit along the cable in a second direction that is opposite the first direction.
Implementation #11: The system of Implementation #10, wherein the input signal processor is configured to determine one or more downhole parameters based on time domain characteristics of the one or more reflected signals.
Implementation #12: The system of Implementation #11, wherein the downhole parameters include temperature, salinity, corrosion rate, fluid composition or any combination thereof.
Implementation #13: The system of any one or more of Implementation #9-12, wherein the one or more sensors includes at least a portion of one or more wires within the cable, one or more components coupled with the one or more wires within the cable, or any combination thereof.
Implementation #14: The system of any one or more of Implementation #9-13, wherein the one or more sensors includes two or more materials, wherein a first material exposed to wellbore fluids at the respective sensor locations.
Implementation #15: The system of any one or more of Implementation #9-14, wherein the one or more sensors modify at least one of resistance and capacitance to cause the impedance mismatch.
Implementation #16: The system of any one or more of Implementation #9-15, wherein the one or more sensors include resistance-based temperature sensors, capacitance-based water cut sensors, inductance-based salinity sensors, or any combination thereof.
Implementation #17: A method comprising: generating, via an input signal processor, an input signal on a cable positioned downhole in a wellbore, wherein the cable includes one or more sensors configured to cause an impedance mismatch at respective sensor locations; detecting, via the input signal processor, a first reflected signal, wherein at least a portion of the input signal is reflected by a first sensor to generate the first reflected signal; and determining, via the input signal processor, one or more downhole parameters based on the first reflected signal.
Implementation #18: The method of Implementation #17, wherein a remaining input signal that is not reflected at the first sensor continues transmitting on the cable in a first direction, and wherein the first reflected signal transmits on the cable in a second direction that is opposite the first direction.
Implementation #19: The method of Implementation #18, wherein at least a portion of the remaining input signal is reflected by a second sensor to generate a second reflected signal.
Implementation #20: The method of any one or more of Implementation #17-19 further comprising: determining, via the input signal processor, the one or more downhole parameters at a location of the first sensor based on time domain characteristics of the first reflected signal.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. An apparatus comprising:
a cable positioned in a wellbore formed in a subsurface formation, wherein an input signal is to be transmitted along the cable; and
one or more sensors positioned on the cable and configured to cause an impedance mismatch at respective sensor locations on the cable to reflect at least a portion of the input signal.

2. The apparatus of claim 1, wherein the input signal transmits along the cable in a first direction, and wherein one or more reflected signals transmit along the cable in a second direction that is opposite the first direction.

3. The apparatus of claim 2 further comprising:
an input signal processor configured to send the input signal along the cable in the first direction, wherein the input signal processor is configured to determine one or more downhole parameters based on time domain characteristics of the one or more reflected signals.

4. The apparatus of claim 3, wherein the downhole parameters include temperature, salinity, corrosion rate, fluid composition, or any combination thereof.

5. The apparatus of claim 1, wherein the one or more sensors include at least a portion of one or more wires within the cable, one or more components coupled with the one or more wires within the cable, or any combination thereof.

6. The apparatus of claim 1, wherein the one or more sensors includes two or more materials, wherein a first material exposed to wellbore fluids at the respective sensor locations.

7. The apparatus of claim 1, wherein the cable includes one or more wires, and wherein a first sensor of the one or more sensors is at least a portion of a first wire of the one or more wires that is exposed to downhole conditions.

8. The apparatus of claim 1, wherein the one or more sensors modifies at least one of resistance and capacitance to cause the impedance mismatch.

9. A system comprising:
a cable positioned in a wellbore formed in a subsurface formation, wherein an input signal is to be transmitted along the cable;
an input signal processor configured to send the input signal along the cable in a first direction; and
one or more sensors positioned on the cable and configured to cause an impedance mismatch at respective sensor locations on the cable to reflect at least a portion of the input signal.

10. The system of claim 9, wherein one or more reflected signals transmit along the cable in a second direction that is opposite the first direction.

11. The system of claim 10, wherein the input signal processor is configured to determine one or more downhole parameters based on time domain characteristics of the one or more reflected signals.

12. The system of claim 11, wherein the downhole parameters include temperature, salinity, corrosion rate, fluid composition or any combination thereof.

13. The system of claim 9, wherein the one or more sensors includes at least a portion of one or more wires within the cable, one or more components coupled with the one or more wires within the cable, or any combination thereof.

14. The system of claim 9, wherein the one or more sensors includes two or more materials, wherein a first material exposed to wellbore fluids at the respective sensor locations.

15. The system of claim 9, wherein the one or more sensors modify at least one of resistance and capacitance to cause the impedance mismatch.

16. The system of claim 9, wherein the one or more sensors include resistance-based temperature sensors, capacitance-based water cut sensors, inductance-based salinity sensors, or any combination thereof.

17. A method comprising:
generating, via an input signal processor, an input signal on a cable positioned downhole in a wellbore, wherein the cable includes one or more sensors configured to cause an impedance mismatch at respective sensor locations;
detecting, via the input signal processor, a first reflected signal, wherein at least a portion of the input signal is reflected by a first sensor to generate the first reflected signal; and
determining, via the input signal processor, one or more downhole parameters based on the first reflected signal.

18. The method of claim 17, wherein a remaining input signal that is not reflected at the first sensor continues transmitting on the cable in a first direction, and wherein the first reflected signal transmits on the cable in a second direction that is opposite the first direction.

19. The method of claim 18, wherein at least a portion of the remaining input signal is reflected by a second sensor to generate a second reflected signal.

20. The method of claim 17 further comprising:
determining, via the input signal processor, the one or more downhole parameters at a location of the first sensor based on time domain characteristics of the first reflected signal.
